(19) United States
(12) Patent Application Publication
(10) Pub. No.: US 2017/0109080 A1
(43) Pub. Date: Apr. 20, 2017

(54) COMPUTING SYSTEM WITH MEMORY MANAGEMENT MECHANISM AND METHOD OF OPERATION THEREOF

(71) Applicant: Samsung Electronics Co., Ltd., Suwon-si (KR)

(72) Inventors: Fei Liu, Fremont, CA (US); Yang Seok Ki, Palo Alto, CA (US); Xiling Sun, San Jose, CA (US)

(21) Appl. No.: 15/062,855

(22) Filed: Mar. 7, 2016

Related U.S. Application Data
(60) Provisional application No. 62/241,554, filed on Oct. 14, 2015.

(51) Int. Cl. G06F 3/06; G06F 12/02

(52) U.S. Cl. CPC G06F 3/0613; G06F 3/0626; G06F 3/0631; G06F 3/0673; G06F 12/023; G06F 2212/1016; G06F 2212/1056; G06F 2212/608

(57) ABSTRACT

A computing system includes a memory module, including a memory bank and a memory rank; and a control unit, coupled to the memory module, configured to: determine a core memory affinity between an aggregated memory and a CPU core; designate the memory bank and the memory rank, from the aggregated memory, as a core affiliated memory for the CPU core based on the core memory affinity; and allocate a slab class from the core affiliated memory to an application program based on a core application affinity with the CPU core.

### CROSS-REFERENCE TO RELATED APPLICATION(S)

This application claims the benefit of U.S. Provisional Patent Application Ser. No. 62/241,554 filed Oct. 14, 2015, and the subject matter thereof is incorporated herein by reference thereto.

### TECHNICAL FIELD

An embodiment of the present invention relates generally to a computing system, and more particularly to a system for memory management.

### BACKGROUND

Modern consumer and industrial electronics, especially devices such key value devices, are providing increasing levels of functionality to support modern life including analysis of big data and real time web applications. Research and development in the existing technologies can take a myriad of different directions.

As users become more empowered with the growth of information processing technology, new and old paradigms begin to take advantage of this new space. One area of electronics based growth, where processing high volumes of information is quintessential, is in big data analysis, such as with non-Structured Query Language (“NoSQL” or “NonSQL”) based systems. However, high input/output per second (IOPS) throughput with efficient memory management has eluded those of skill in the art.

Thus, a need still remains for a computing system with memory management mechanism for memory allocation. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides a system including: a memory module, including a memory bank and a memory rank; and a control unit, coupled to the memory module, configured to: determine a core memory affinity between an aggregated memory and a CPU core; designate the memory bank and the memory rank, from the aggregated memory, as a core affiliated memory for the CPU core based on the core memory affinity; and allocate a slab class from the core affiliated memory to an application program based on a core application affinity with the CPU core.

An embodiment of the present invention provides a method including: determining a core memory affinity between an aggregated memory and a CPU core; designating a memory bank and a memory rank of a memory module, from the aggregated memory, as a core affiliated memory of the CPU core based on the core memory affinity; and allocating a slab class from the core affiliated memory to an application program based on a core application affinity with the CPU core.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a computing system with memory management mechanism in an embodiment of the present invention.

FIG. 2 is an example of a global cache map for the computing system.

FIG. 3 is a further example of the global cache map for the computing system.

FIG. 4 is an example of memory allocation for the computing system.

FIG. 5 is a flow chart for the computing system.

FIG. 6 is an example flow chart for memory allocation of the computing system.

FIG. 7 is a flow chart of a method of operation of a computing system in an embodiment of the present invention.

### DETAILED DESCRIPTION

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

In the following description, numerous specific details are given to provide a thorough understanding of the invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation. The embodiments have been numbered first embodiment, second embodiment, etc. as a matter of descriptive convenience and are not intended to have any other significance or provide limitations for an embodiment of the present invention.

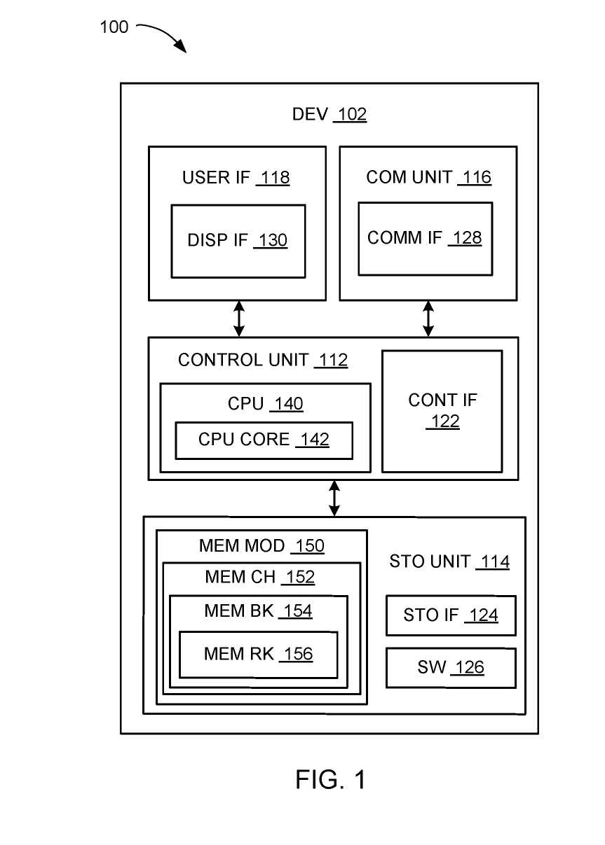

Referring now to FIG. 1, therein is shown a computing system 100 with a memory management mechanism in an embodiment of the present invention. FIG. 1 depicts an example block diagram of a computing system 100.

The computing system 100 can include a device 102. For example, the device 102 can be a computing device, such as a server, smartphone, laptop computer or desktop computer. In another example, the device 102 can include a variety of centralized or decentralized computing devices. As a specific example, the device 102 can be a grid-computing resources, a virtualized computer resource, cloud computing resource, peer-to-peer distributed computing devices, or a combination thereof.

The device 102 can be a device capable of supporting or implementing a key-value store or database in, such as NoSQL databases, and executing big data and real-time web applications, or a combination thereof. For example, device 102 can include implementation of the key value store with non-volatile data storage, such as flash memory.

The device 102 can include units, such as hardware components, including a control unit 112, a storage unit 114, a communication unit 116, and a user interface 118. The units in the device 102 can work individually and independently of the other units or in cooperatively with one or more of the other units.

The control unit 112 can include a control interface 122. The control unit 112 can execute a software 126 to provide the intelligence of the computing system 100.

The control unit 112 can be implemented in a number of different manners of hardware circuitry. For example, the control unit 112 can be a processor, an application specific integrated circuit (ASIC) an embedded processor, a microprocessor, a hardware control logic, a hardware finite state machine (FSM), a digital signal processor (DSP), a programmable logic device (PLD), or a combination thereof. The control unit 112 can be further implemented as a central processing unit (CPU) having one or more CPU cores 142, which can be a basic or fundamental computational unit of the CPU. The control unit 112 can include dedicated circuitry, such as a memory controller, memory chip controller, or memory controller unit, for memory allocation operations and flow of information.

The control interface 122 can be used for communication between the control unit 112 and other units in the device 102. The control interface 122 can also be used for communication that is external to the device 102.

The control interface 122 can receive information from the other units or from external sources, or can transmit information to the other units or to external destinations. The external sources and the external destinations refer to sources and destinations external to the device 102.

The control interface 122 can be implemented in different ways with hardware circuitry and can include different implementations depending on which internal units or external units are being interfaced with the control interface 122. For example, the control interface 122 can be implemented with a pressure sensor, an inertial sensor, a microelectromechanical system (MEMS), optical circuitry, waveguides, wireless circuitry, wireline circuitry, or a combination thereof.

The storage unit 114 can store the software 126. The storage unit 114 can also store the relevant information, such as data representing incoming images, data representing previously presented image, sound files, or a combination thereof.

The storage unit 114 can be implemented with hardware circuitry including a volatile memory, a nonvolatile memory, an internal memory, an external memory, or a combination thereof. For example, the storage unit 114 can be a nonvolatile storage such as non-volatile random access memory (NVRAM), Flash memory, disk storage, resistive random-access memory (ReRAM), Phase-change memory (PRAM), or a volatile storage such as static random access memory (SRAM). As a specific example, the storage unit 114 can include random access memory (RAM), dynamic random-access memory (DRAM), synchronous dynamic-access memory (SDRAM), or a combination thereof, in the form of memory modules 150, which are hardware modules, such as dual in-line memory modules (DIMM). The memory modules 150 can be divided into memory channels 152, memory banks 154, and memory ranks 156. The memory modules 150 of the storage unit 114, can be physically addressable and have direct memory access (DMA) functionality.

The storage unit 114 can include a storage interface 124. The storage interface 124 can be used for communication between other units in the device 102. The storage interface 124 can also be used for communication that is external to the device 102.

The storage interface 124 can receive information from the other units or from external sources, or can transmit information to the other units or to external destinations. The external sources and the external destinations refer to sources and destinations external to the device 102.

The storage interface 124 can include different implementations depending on which units or external units are being interfaced with the storage unit 114. The storage interface 124 can be implemented with technologies and techniques similar to the implementation of the control interface 122.

The communication unit 116 can enable external communication to and from the device 102. For example, the communication unit 116 can permit the device 102 to communicate with an attachment, such as a peripheral device or a computer desktop. The communication unit 116 can include active and passive components, such as microelectronics, filters, modulators, demodulators, detectors, decoders, a base band modem, or an antenna.

The communication unit 116 can include a communication interface 128. The communication interface 128 can be used for communication between the communication unit 116 and other units in the device 102. The communication interface 128 can receive information from the other units or can transmit information to the other units.

The communication interface 128 can include different implementations depending on which units are being interfaced with the communication unit 116. The communication interface 128 can be implemented with technologies and techniques similar to the implementation of the control interface 122.

The user interface 118 allows a user (not shown) to interface and interact with the device 102. The user interface 118 can include an input device and an output device. Examples of the input device of the user interface 118 can include a keypad, a touchpad, soft-keys, a keyboard, a microphone, an infrared sensor for receiving remote signals, or any combination thereof to provide data and communication inputs.

The user interface 118 can include a display interface 130. The display interface 130 can include a display, a projector, a video screen, a speaker, or any combination thereof.

The control unit 112 can operate the user interface 118 to display information generated by the computing system 100. The control unit 112 can also execute the software 126 for the other functions of the computing system 100. The control unit 112 can further execute the software 126 for interaction with the communication path 104 via the communication unit 116.

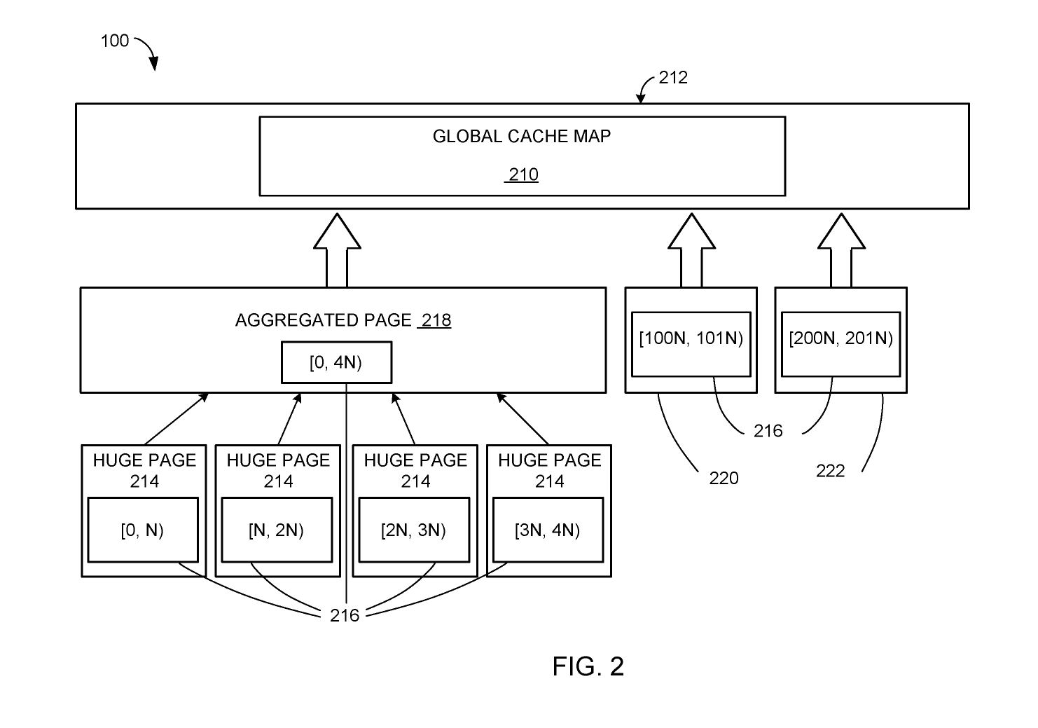

Referring now to FIG. 2, therein is shown an example of a global cache map 210 for the computing system 100. The global cache map 210 is a memory pool for dynamic memory allocation. For example, the global cache map 210 can be a map of an aggregated memory 212, which is memory allocated by the operating system of the computing system 100. As an example, the aggregated memory 212 can be the total amount of direct access memory reserved from the operating system. The aggregated memory 212 can be portioned as memory pages, which are the smallest or fundamental quantities of memory.

The global cache map 210 can be organized or arranged to map the aggregated memory 212 as one or more “huge pages” 214. The huge pages 214 are single sections of physically continuous memory generated from the physically contiguous instances of the memory pages. Generation of the huge pages 214 will be discussed below. Each of the huge pages 214 can be indexed in the global cache map 210 based on a page memory address 216. For example, the page memory address 216 for each of the huge pages 214 can be indexed as the logical addresses that represent a range of physically continuous memory addresses, such as [0, N) for a first instance of the huge pages 214, and so forth, to [3N, 4N) a fourth instance of the huge pages 214.

The global cache map 210 can further organize the huge pages 214 as an aggregated page 218. The aggregated page 218 is a grouping or aggregation of one or more segments of physically continuous memory. For example, the aggregated page 218 can be a grouping of physically adjacent instances of the huge pages 214. The aggregated page 218 can be addressed in the global cache map 210 based on the individual instances of the huge pages 214 in the aggregated page 218. For example, the page memory address 216 for the aggregated page 218 can be [0, 4N) when the aggregated page 218 includes the huge pages 214 with the page memory address 216 ranging from [0, N) to [3N, 4N). For illustrative purposes, the aggregated page 218 is shown to include four instances of the huge pages 214, although it is understood that the aggregated page 218 can include a different number of the huge pages 214.

The global cache map 210 can include multiple instances of the aggregated page 218. For example, each instance of the aggregated page 218 can represent the greatest number of physically continuous instances of the huge pages 218 within the memory module 150 of FIG. 1. As illustrated in FIG. 2 for example, the greatest number for the aggregated page 218 can be four instances of the huge pages 210 when the maximum number of adjacent instance of the huge pages 210 that are physically contiguous is a series of four of the huge pages 210.

For illustrative purposes, the global cache map 210 is shown additional instances of the aggregated page 218, which are shown as a second aggregated page 220 and a third aggregated page 222, although it is understood that the global cache map 210 can include a different number of the aggregated page 218. In this illustration, the second aggregated page 220 and third aggregated page 222 having the page memory address 216 of ranges [100N, 101N) and [200N, 201N), respectively, are shown without the associated instances of the huge pages 210, although it is understood that the second aggregated page 220 and third aggregated page 222 include one or more of the huge pages 210. The aggregated page 218 can represent the total memory in the global cache map 210.

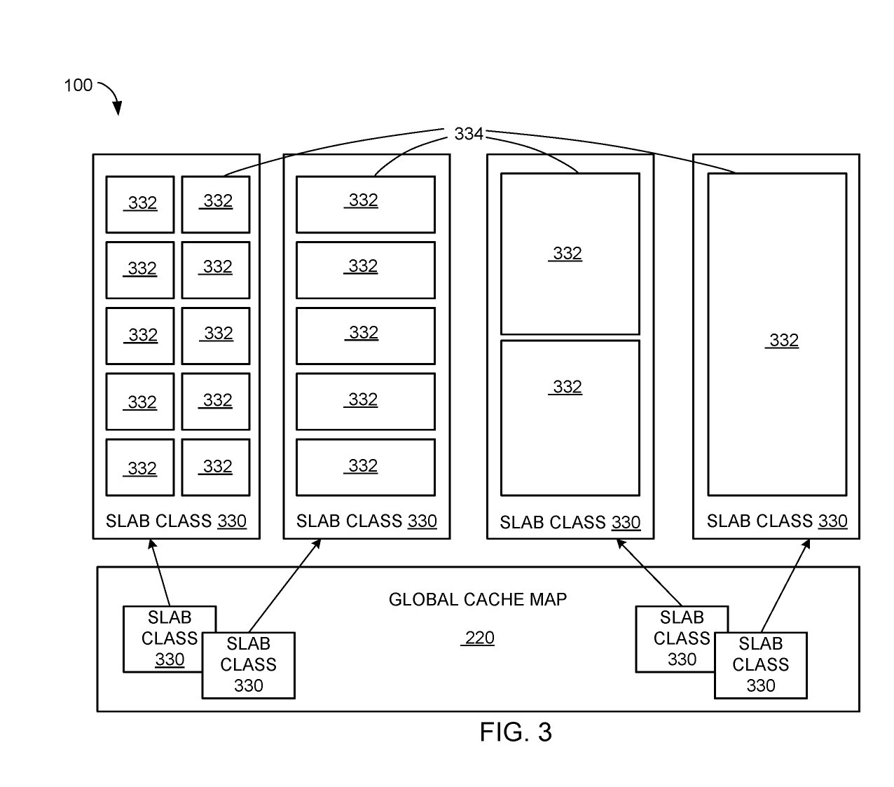

Referring now to FIG. 3, therein is shown a further example of the global cache map 210 for the computing system 100. The aggregated memory 212 of FIG. 2 within the global cache map 210 can be organized into slab classes 330. The slab classes 330 is a classification of the size of memory segments. The global cache map 210 can include multiple instances of the slab classes 330.

The global cache map 210 can simultaneously maintain multiple instances of the slab classes 330 that include static or dynamic memory allocations. For example, the maximum amount of available memory, such as the total amount of memory of the memory module 150 of FIG. 1 available for distribution, can be allocated on a first come first serve basis to each of the slab classes 330. To continue the example, based on the distribution of the available memory to the different instances of the slab classes 330, the memory allocation of the slab classes 330 can be similar or different from one another. As a specific example, the size of a given instance of the slab classes 330 can be increased or decreased by the further allocation or deallocation of memory pages or subdivisions of the huge pages 214.

In another example, the size of the slab classes 330 can be consistent among the different instances of the slab classes 330. More specifically the amount of memory in each of the slab classes 330 can be similar or equivalent. As an example, the slab classes 330 can each be configured to 2 megabytes or 16 megabytes, although it is understood that the size of the slab classes 330 can be of a different value.

The slab classes 330 can include the slab chunks 332, which are sections of physically continuous memory. In general, a chunk size 334 for the slab chunks 332 in any one of the slab classes 330 are of a fixed size while the chunk size 334 of the slab chunks 332 among different instances of the slab classes 330 can have a different size. For example, as illustrated in FIG. 3, the slab classes 330 having the same or similar allocation of memory can have slab chunks 332 that differ in size. As a specific example, each of the slab classes 330 can be allocated 1020 bytes of memory. To continue the example, one of the slab classes 330 can include multiple instances of the slab chunks 332 each having a chunk size 334 of 96 bytes while another one of the slab classes 330 can include a single instance of the slab chunks 332 having a chunk size 334 of 1024 bytes. The chunk size 334 of the slab chunks 332 can be predetermined or set to default sizes. The memory within each of the slab chunks 332 is physically continuous. However the memory between each of the slab chunks 332 can be non-continuous. The slab chunks 332 can be generated from the memory allocations from the huge pages 214, which will be discuss below.

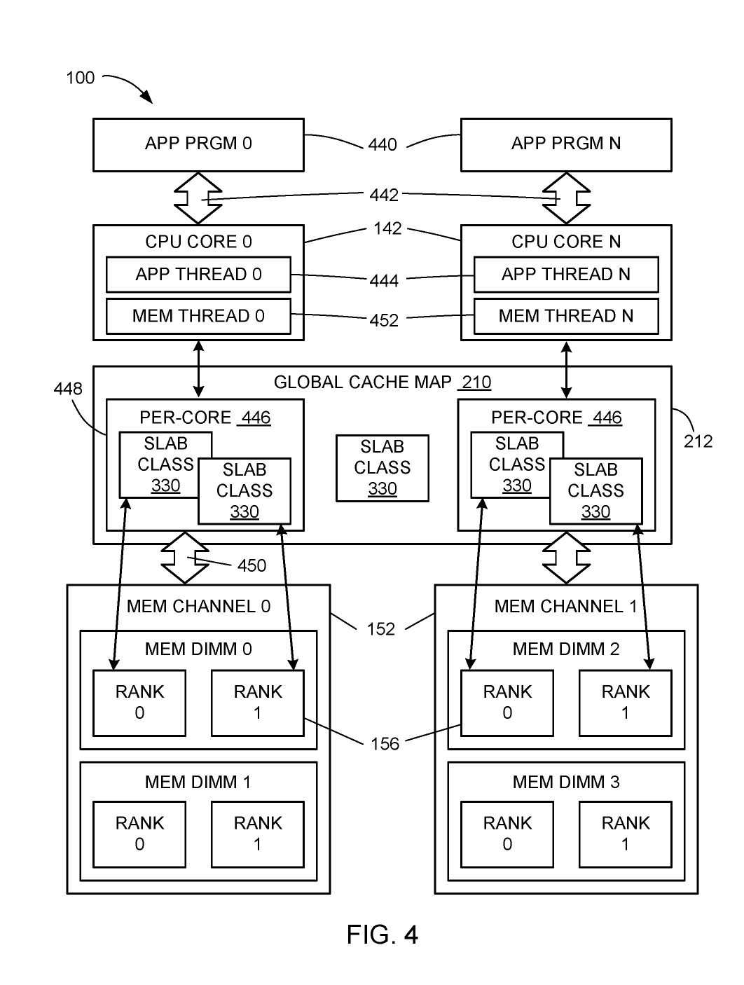

Referring now to FIG. 4, therein is shown an example of memory allocation for the computing system 100. FIG. 4 depicts the relationship between the CPU cores 142, the aggregated memory 212, and an application program 440.

The application program 440 can be a software program being executed with the computing system 100. For example, the application program 440 can be an application for analyzing big data or a real time web application. The application program 440 can have a core application affinity 442 with one of the CPU cores 142. The core application affinity 442 is a binding of an application, such as the application program 440, with one of the CPU cores 142. As an example, binding of the application program 440 can designate the application program 440 to one of the CPU cores 142 such that the application program 440 will be executed exclusively with the designated instance of the CPU cores 142.

The core application affinity 442 can be based on an application thread 444. As an example, the application thread 444 can be the remnant or residual threads of an application or process, such as the application program 440, remaining in the cache of one of the CPU cores 142.

Each of the CPU cores 142 can be assigned a core affiliated memory 448. The core affiliated memory 448 is memory that is designated to a specific instance of the CPU cores 142. For example, the core affiliated memory 448 can be bound to one of the CPU cores 142 such that only the designated instance of the CPU cores 142 can utilize the core affiliated memory 448. As a specific example, the core affiliated memory 448 can be used exclusively for execution of the application program 442 having the core application affinity 442 by an instance of the CPU core 142 having a core memory affinity 450 with the instance of the CPU cores 142.

The core affiliated memory 448 can be designated based on a core memory affinity 450. The core memory affinity 450 can be based on a memory affinity thread 452. The memory affinity thread 452 can be an indication of processing that has occurred previously using a particular allocation of memory. For example, the core affiliated memory 448 having the core memory affinity 450 can be bound to one of the CPU cores 142 based on the physical address of core affiliated memory 448, such as the memory channel 152, the memory bank 154 of FIG. 1, the memory rank 156, or a combination thereof.

The core affiliated memory 448 can be indexed with a per-core cache map 446. The per-core cache map 446 is a memory pool that is specific to one of the CPU cores 142. For example, the per-core cache map 446 include the memory addresses for core affiliated memory 448. Each instance of the CPU cores 142 has access to a corresponding instance of the per-core cache map 446.

The slab classes 330 can be allocated to the per-core cache map 446 from the global cache map 210 based on the core memory affinity 452, the needs of the application program 440, or a combination thereof. For example, the slab classes 330 can be allocated to the per-core cache map 446 based on the chunk size 334 that is optimal for accommodating or handling the data objects for the application program 440. The slab classes 330 of the core affiliated memory 448 can be assigned from the memory modules 150, including the memory channels 152, memory banks 154 of FIG. 1, and memory ranks 156, having the core memory affinity 450 specific to one of the CPU cores 142. The functions for memory allocation for the computing system 100 will be discussed in detail below.

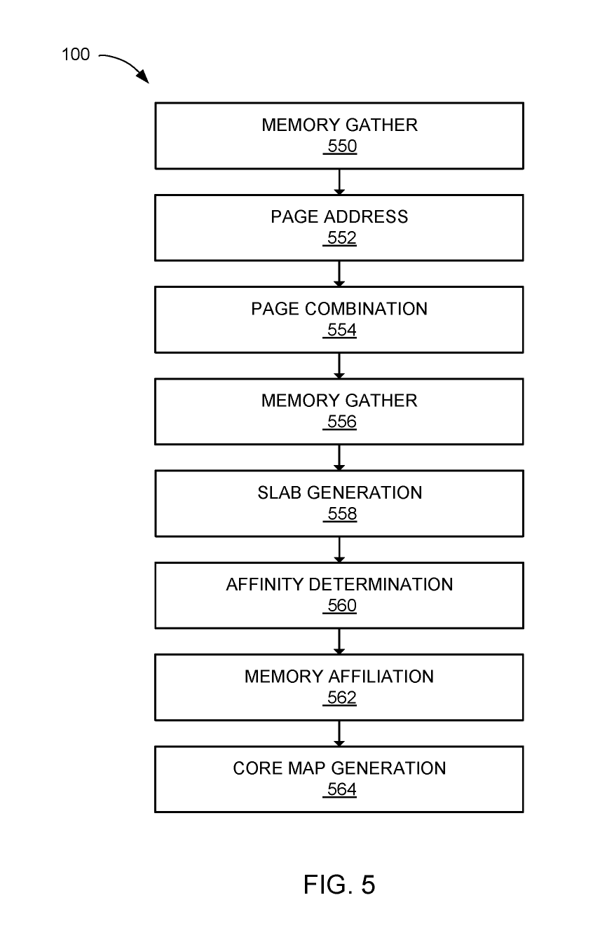

Referring now to FIG. 5, therein is shown a flow chart for the computing system 100. The memory management mechanism of the computing system 100 can be implemented in a number of different ways. One example of the implementation is described in the flow chart below. In general, the flow chart depicts the allocation of physically continuous memory, such as the core affiliated memory 448 of FIG. 4 from the aggregated memory 212 of FIG. 2. The aggregated memory 212 can be DMA addressable. Furthermore, the aggregated memory 212 and the core affiliated memory 448 can be translated to the physical addresses such that the inputs and outputs (I/O) issued by the application program 440 of FIG. 4 can use the physical addresses to fill each of the I/O commands. It has been discovered that the core affiliated memory 448 of the memory management mechanism can eliminate the need for memory copy operations and data structure changes from the application program 440 to the device 102, which improves memory efficiency for the computing system 100.

The flow for the memory management mechanism can be initiated with a memory gather process 550. The memory gather process 550 is for gathering the available memory from the operating system to generate the aggregated memory 212. For example, the physically continuous memory can be reserved through or from the operating system of the computing system 100. The memory gather process 550 can be implemented by the control unit 112 to generate the aggregated memory 212. For example, the control unit 112 can interface with the storage unit 114 to reserve the physically continuous memory within the storage unit 114.

The flow can continue to a page address process 552. The page address process 552 is for generating the huge pages 214 of FIG. 2. Each of the huge pages 214 can be combine from the memory pages, which can be the smallest segment or portion of physically continuous memory within the memory module 150, and can be for memory management in a virtual memory system. More specifically, the huge pages 214 can be generated from physically contiguous instances of the memory pages from the aggregated memory 212 within one of the memory ranks 156 of one of the memory banks 154.

The size of the huge pages 214 can be generated based on factors or properties, such as CPU or RAM architecture, type, operating mode, or addressing mode of a processor associated with the control unit 112, the CPU cores 142, or a combination thereof. For example, the page address process 552 can be implemented by the operating system to select the size of the huge page that is supported by the processor architecture associated with the control unit 112, the CPU cores 142, or a combination thereof. The huge pages 214 can be generated in the kernel space of the operating system, as opposed to the user space. The page address process 552 can be implemented by the control unit 112 to generate the huge pages 214.

The flow can continue to a page combination process 554. The page combination process 554 is for generating the aggregated page 218 of FIG. 2. As an example, the aggregated page 218 can be generated by combining two or more physically adjacent instances of the huge pages 214 in an instance of the memory ranks 156 belonging to an instance of the memory banks 154. In another example, the aggregated page 218 can be generated at the level of the memory rank 156 of FIG. 1, such that the aggregated page 218 is generated from the memory within one instance of the memory rank 156. In another example, the page combination process 554 can be performed in a user space with a user space device driver. The page combination process 554 can be implemented by the control unit 112 to generate the aggregated page 218 as described above.

It has been discovered that the computing system 100 improves efficiency of memory allocation by generating the aggregated page 218 in the user space with the user space device driver. The user space device driver reduces the overhead and loading of the kernel device driver, which improves efficiency of memory allocation.

The flow can continue to a global map generation process 556. The global map generation process 556 is for generating the global cache map 210 of FIG. 2. For example, the global cache map 210 can be generated as a map that includes the physical memory addresses of the aggregated page 218 and the associated instances of the huge pages 214. The global map generation process 556 can be implemented by the control unit 112 to generate the global map cache 210 as described above.

The flow can continue to a slab generation process 558. The slab generation process 558 is for allocating or portioning the aggregated memory 212 from one of the huge pages 212 into the slab classes 330 and the slab chunks 332, both of FIG. 3. For example, a slab algorithm can be implemented to portion or organize the global cache map 210 into the slab classes 330. The amount of memory allocated to the slab classes 330 can be set consistently among different instances of the slab classes 330. More specifically, similar or equivalent amounts of memory can be allocated to each of the slab classes 330, which can enable full or optimal use memory alignment benefits. For example, the slab classes 330 can be of a predetermined size based on available memory within the memory channel 152, the memory bank 154, the memory rank 156, or a combination thereof. As a specific example, the slab classes 330 can be configured to the size of 2 MB or 16 MB, although it is understood that the size of the slab classes 330 can be of a different value.

Each of the slab classes 330 can organized into the slab chunks 332 of FIG. 3. The slab chunks 332 of the slab classes 330 can be generated from physically continuous portions of memory. For example, the slab chunks 332 for the slab classes 330 can be allocated from the aggregated memory 212 of one of the huge pages 214. As a specific example, the slab generation process 558 can be implemented by the control unit 112 to generate the slab chunks 332 by allocating one or more of the memory pages from the aggregated memory 212 of one of the huge pages 214.

The chunk size 334 for each of the slab chunks 332 for a given instance of the slab classes 330 can be of fixed size. Among different instances of the slab classes 330, the slab chunks 332 can be generated having different values of the chunk size 334. For example, the slab generation process 558 can generate the chunk size 334 suitable to fit the objects, such as kernel data objects or data objects of the application program 440. As a specific example, the chunk size 334 of a slab chunk 332 of can be proportional to the size of the huge pages 214 or a portion of the huge pages 214, such as a combination of one or more physically continuous instances of memory pages within the huge pages 214. For instance, slab chunks 332 can be divided as “large slabs” for objects that are greater than ⅛ the size of the page or sub-division within the huge pages 214, or “small slabs” objects that are less than ⅛ the size of the page or sub-division within the huge pages 214. The slab generation process 558 can be implemented by the control unit 112 to portion the aggregated memory 212 into the slab classes 330 and the slab chunks 332 as described above.

The flow can continue to an affinity determination process 560. The affinity determination process 560 is for determining CPU affinity with the memory. The core memory affinity 450 of FIG. 4 can be determined associating each of the CPU cores 142 of FIG. 1 with the memory affinity thread 452 of FIG. 4. For example, the memory affinity thread 452 for a specific instance the CPU cores 142 can be determine when there is a processes or application associated with an instance of the CPU cores 142 running on a particular set of the aggregated memory 212. The affinity determination process 560 can be implemented by the control unit 112 to determine the core memory affinity 450 as described above.

The flow can continue to a memory affiliation process 562. The memory affiliation process 562 is for designating memory with the CPU cores 142 based on the core memory affinity 450. For example, the memory channels 152, the memory banks 154, the memory ranks 156, or a combination thereof for one of the memory modules 150 of FIG. 1 that have been determined to have the core memory affinity 450 with a specific instance of the CPU cores 142 can be designated as the core affiliated memory 448 of FIG. 4. As a specific example, the memory affiliation process 562 can designate the slab classes 330 for one of the memory ranks 156, the memory banks 154, the memory channels 152, or a combination thereof, with which the instance of the CPU cores 142 has previously used for execution of the application program 440. To further the specific example, the memory affiliation process 562 can designate the slab classes 330 having the chunk size 334 that is most suited for the size of the data objects of the application program 440. The memory affiliation process 562 can be implemented by the control unit 112 to designate memory with the CPU cores 142 as described above.

The flow can continue to a core map generation process 564. The core map generation process 564 is for generating the per-core cache map 446 of FIG. 4. The per-core cache map 446 can be generated based on the physical memory address of the core affiliated memory 448. For example, in the core map generation process 564, the per-core cache map 446 can be generated as a map of the physical memory address representing the memory channels 152, the memory banks 154, the memory ranks 156, or a combination thereof of the core affiliated memory 448. As a specific example, the per-core cache map 446 can be generated according to the huge pages 214 associated with a specific instance of the memory channels 152, the memory banks 154, the memory ranks 156, or a combination thereof that has been designated to a specific one of the CPU cores 142.

Affiliation of different instances of the memory channels 152 with the per-core cache map 446 of the CPU cores 142 enables channel level parallelism. Each of the slab classes 330 allocated to the per-core cache map 446 associated with the memory ranks 156 for an instance of the memory channels 152 enables rank level parallelism. The core map generation process 564 can be implemented by the control unit 112 to generate the per-core cache map 446 associated with the core affiliated memory 448 as describe above.

It has been discovered that the core affiliated memory 448 for the CPU cores 142 can fully utilize the available parallelisms of the memory channels 152 and memory ranks 156, which improves performance. The channel level parallelism and the rank level parallelism enables equal loading across the levels of the memory channels 152 and levels of the memory ranks 156 which improves the performance computing system 100, especially for multiple-queue applications when executing I/O commands in each queue.

It has further been discovered that generating the slab chunks 332 of the slab classes 330 from the aggregated memory 212 of one of the huge pages 214 enables parallelism between the memory channels 152, memory banks 154, memory ranks 156, or a combination thereof, which improves performance of the computing system 100. Since the huge pages 214 can be aggregated from physically continuous instances of the memory pages within one of the memory ranks 156 of one of the memory banks 154, each of the memory banks 154 can operate in parallel, which improves performance of the computing system 100.

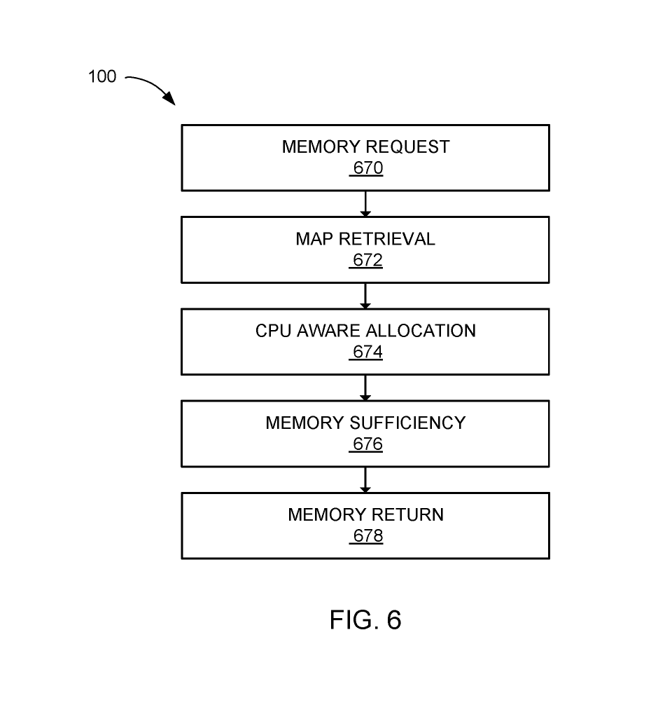

Referring now to FIG. 6, therein is shown an example flow chart for memory allocation of the computing system 100. The flow can be initiated when the application program 440 of FIG. 4 request access to the aggregated memory 212 of FIG. 2 in a memory request 670. An instance of the CPU cores 142 of FIG. 1 having the core application affinity 442 of FIG. 4 with application program 440 can be determined by based on the application thread 444 of FIG. 4. Once the instance of the CPU cores 142 affiliated with the application program 440 has been determined, the per-core cache map 446 affiliated with the instance of the CPU cores 142 can be retrieved from the global cache map 210 in a map retrieval process 672. As an example, the memory request 670 can be received by the control unit 112 through the control interface 122, both of FIG. 1.

The flow can continue to a CPU aware allocation process 674. The CPU aware allocation process 674 is for allocating memory to the application program 440 based on affinity with the CPU cores 142. Since the per-core cache map 446 is generated based on the core memory affinity 450, the allocation of the core affiliated memory 448 to the application program 440 provides binding between the core affiliated memory 448, the CPU cores 142, and the application program 440.

The slab classes 330 can be allocated from the core affiliated memory 448 based on the needs of the application program 440. For example, one of the slab classes 330 that is appropriate for the application program 440 can be selected as the slab classes 330 having the chunk size 334 that match the needs of the application program 440.

As a specific example, the core affiliated memory 448 can be allocated according to the memory banks 154 and the memory ranks 156 associated with one of the CPU cores 142. For instance, for the memory banks 154 associated with the specific instance of the CPU cores 142 and the memory ranks 156 belonging to the memory banks 154, the slab classes 330 can be allocated having the chunk size 334 that is proper for the application program 440. The allocation of the slab classes 330 can be recorded into the per-core cache map 446.

The per-core cache map 446 can be expanded as required by the application program 440 affiliated with the CPU cores 142 with a memory sufficiency process 676. The memory sufficiency process 676 is for determining if the allocation of the core affiliated memory 448 is sufficient for the application program 440. For example, when the current per-core cache map 446 does not have enough free instances of the slab classes 330 for the application program 440, additional instances of the slab classes 330 can be allocated from the global cache map 210 to the per-core cache map 446. The CPU aware allocation process 674 can be implemented by the control unit 112 to designate the core affiliated memory 448 to the application program 440 as described above.

The flow can continue to a memory return process 678. The memory return process 678 is for returning the core affiliated memory 448 to the global cache map 210. For example, once it is determined that the application program 440 no longer needs the core affiliated memory 448, the slab classes 330 can be returned to the aggregated memory 212. In another example, the per-core cache map 446 can be returned to the global cache map 210 when it is determined that the CPU cores 142 no longer need the per-core cache map 446. The memory return process 678 can be implemented by the control unit 112 and can interface with the storage unit 114 to return or deallocate the core affiliated memory 448 as described above.

It has been found that, in terms of CPU usage, the cost of multiple instances of the CPU cores 142 accessing the slab classes 330 from the global cache map 210 can reduce speed and performance since each access to the slab classes 330 requires a global lock to the entirety of the slab classes 330. However, it has been discovered that memory allocation for the application program 440 from the per-core cache map 446 prevents the global lock on an entire instance of the slab classes 330. The per-core cache map 446 for each of the CPU cores 142 include local locks that do not affect the memory allocations from the global cache map 210 to other instances of the CPU cores 142, which prevents a global lock on the slab classes 330.

The processes described in this application can be implemented as instructions stored on a non-transitory computer readable medium to be executed by the control unit 112 of FIG. 1. The non-transitory computer medium can include the storage unit 114 of FIG. 1. The non-transitory computer readable medium can include non-volatile memory, such as a hard disk drive, non-volatile random access memory (NVRAM), solid-state storage device (SSD), compact disk (CD), digital video disk (DVD), or universal serial bus (USB) flash memory devices. The non-transitory computer readable medium can be integrated as a part of the computing system 100 or installed as a removable portion of the computing system 100.

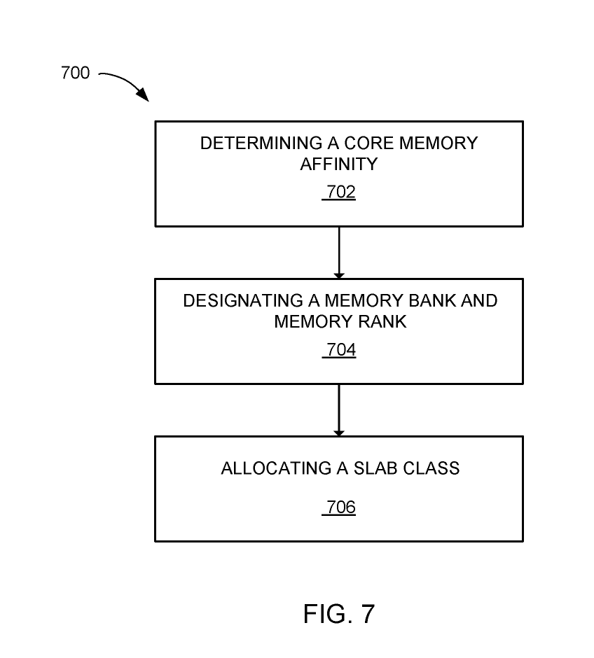

Referring now to FIG. 7, therein is shown a flow chart of a method 700 of operation of a computing system 100 in an embodiment of the present invention. The method 700 includes: determining a core memory affinity between an aggregated memory and a CPU core in a block 702; designating a memory bank and a memory rank of a memory module, from the aggregated memory, as a core affiliated memory of the CPU core based on the core memory affinity in a block 704; and allocating a slab class from the core affiliated memory to an application program based on a core application affinity with the CPU core in a block 706. As an example, the blocks of the method 700 can be implemented by the units of the device 102 of FIG. 1, such as the control unit 112 of FIG. 1 and the storage unit 114, as described in the flows described in FIG. 5 and FIG. 6 above.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance.

These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A computing system comprising:
a memory module, including a memory bank and a memory rank; and
a control unit, coupled to the memory module, configured to:
determine a core memory affinity between an aggregated memory and a CPU core;
designate the memory bank and the memory rank, from the aggregated memory, as a core affiliated memory for the CPU core based on the core memory affinity; and
allocate a slab class from the core affiliated memory to an application program based on a core application affinity with the CPU core.

2. The system as claimed in claim 1 wherein the control unit is configured to allocate a slab chunk of the slab class wherein the slab chunk is of physically continuous memory.

3. The system as claimed in claim 1 wherein the control unit is configured to generate a global cache map of the aggregated memory.

4. The system as claimed in claim 1 wherein the control unit is configured to generate a per-core cache map of the core affiliated memory.

5. The system as claimed in claim 1 wherein the control unit is configured to:
aggregate a huge page of physically continuous portions of the aggregated memory within the memory rank of the memory bank;
allocate the aggregated memory from the huge page to generate a slab chunk of the slab class.

6. The system as claimed in claim 1 wherein the control unit is configured to determine the core memory affinity based on a memory affinity thread.

7. The system as claimed in claim 1 wherein the control unit is configured to organize the aggregated memory into multiple instances of the slab classes wherein the size of the slab classes are equivalent.

8. The system as claimed in claim 1 wherein the control unit is configured to expand a per-core cache map with an additional instance of the slab class based on the needs of the application program.

9. The system as claimed in claim 1 wherein the control unit is configured to generate the aggregated memory based on physically adjacent instances of huge pages.

10. The system as claimed in claim 1 wherein the control unit is configured to generate the aggregated memory including direct memory access functionality.

11. A method of operation of a computing system comprising:
determining a core memory affinity between an aggregated memory and a CPU core;
designating a memory bank and a memory rank of a memory module, from the aggregated memory, as a core affiliated memory of the CPU core based on the core memory affinity; and
allocating a slab class from the core affiliated memory to an application program based on a core application affinity with the CPU core.

12. The method as claimed in claim 11 wherein allocating the slab class includes allocating a slab chunk of the slab class wherein the slab chunk is of physically continuous memory.

13. The method as claimed in claim 11 further comprising generating a global cache map of the aggregated memory.

14. The method as claimed in claim 11 further comprising generating a per-core cache map of the core affiliated memory.

15. The method as claimed in claim 11 further comprising:
generating a huge page from physically continuous portions of the aggregated memory within the memory rank of the memory bank; and
allocating the aggregated memory form the huge page to generate a slab chunk of the slab class.

16. The method as claimed in claim 11 wherein determining the core memory affinity includes determining the core memory affinity based on a memory affinity thread.

17. The method as claimed in claim 11 further comprising organizing the aggregated memory into multiple instances of the slab classes wherein the size of the slab classes are equivalent.

18. The method as claimed in claim 11 further comprising expanding a per-core cache map with an additional instance of the slab class based on the needs of the application program.

19. The s method as claimed in claim 11 further comprising generating the aggregated memory based on physically adjacent instances of huge pages.

20. The method as claimed in claim 11 further comprising generating the aggregated memory having direct memory access functionality.
